(19) United States
(12) Patent Application Publication
(10) Pub. No.: US 2026/0287468 A1
(43) Pub. Date: Sep. 24, 2026

(54) METHOD OF DETERMINING WEAR CONDITION OF VALVE

(71) Applicant: SPM Oil & Gas Inc., Fort Worth, TX (US)

(72) Inventors: John Nicklaus Gulliksen, White Settlement, TX (US); Michael C. Zanoff, Fort Worth, TX (US)

(73) Assignee: SPM Oil & Gas Inc., Fort Worth, TX (US)

(21) Appl. No.: 19/085,267

(22) Filed: Mar. 20, 2025

(51) Int. Cl. G01M 13/003; E21B 43/26

(52) U.S. Cl. CPC G01M 13/003; E21B 43/2607

(57) ABSTRACT

A method of determining a wear condition of a wear surface of a suction valve or a discharge valve of a frac pump caused by an operation of the frac pump is provided. The method includes removing a valve body, of the suction valve or the discharge valve, from the frac pump. The method also includes positioning a top portion of a receiving slot of a wear gauge in contact with a top surface of the valve body. The method further includes positioning a contact surface of a movable portion of the wear gauge in contact with the wear surface of the valve body. The method includes determining the wear condition of the wear surface based on a position of the contact surface of the movable portion with respect to the top portion of the receiving slot.

### TECHNICAL FIELD

The present disclosure relates to a method of determining a wear condition of a wear surface of a suction valve or a discharge valve of a frac pump caused by an operation of the frac pump, a wear gauge for determining the wear condition of the wear surface, and a kit including the wear gauge.

### BACKGROUND

Fracturing (frac) pumps, also known as fracking pumps, are commonly deployed at a fracturing worksite. Such frac pumps are typically positive displacement pumps that include a fluid end and a power end. The frac pumps include different types of valves such as flow valves, suction valves, discharge valves, etc. in the fluid end. The valves include a valve body. The valve body has a wear surface. During an operation of the frac pump, it is observed that the valve body gets worn at the wear surface. It is important to identify if the valve body can be used further or should be replaced based on a condition of the wear surface. Thus, the wear surface may have to be checked to ensure that the wear surface has not worn out beyond a usable stage. If the valve body with the worn-out wear surface is continued to use, an efficiency and a reliability of the frac pump may get affected, which is not desirable.

CN204944370 describes a measure gauge of rubber butterfly valve disk seat machining precision. The machining precision of mainly solving present rubber butterfly valve disk seat is not high, and the quality testing personnel are difficult to the problem of detection. Its characterized in that a backup plate one side is equipped with measuring flume that are used for with the laminating of rubber butterfly valve disk seat inner wall adaptation, measuring flume inner wall is equipped with the stellite layer. The utility model provides a measure gauge of rubber butterfly valve disk seat machining precision, including the backup plate, its backup plate inboard is equipped with the measuring flume with disk seat inner wall adaptation, in the time of the use with the gauge lean on can audio-visual measurement processing at the disk seat inner wall the precision, and be equipped with the stellite layer on the measuring flume, wear-resisting corrosion-resistant, long service life.

### SUMMARY OF THE DISCLOSURE

In an aspect of the present disclosure, a method of determining a wear condition of a wear surface of a suction valve or a discharge valve of a frac pump caused by an operation of the frac pump is provided. The method includes removing a valve body, of the suction valve or the discharge valve, from the frac pump. The method also includes positioning a top portion of a receiving slot of a wear gauge in contact with a top surface of the valve body. The method further includes positioning a contact surface of a movable portion of the wear gauge in contact with the wear surface of the valve body. The method includes determining the wear condition of the wear surface based on a position of the contact surface of the movable portion with respect to the top portion of the receiving slot.

In another aspect of the present disclosure, a wear gauge for determining a wear condition of a wear surface of a suction valve or a discharge valve of a frac pump caused by an operation of the frac pump is provided. The wear gauge includes a body defining a first end and a second end disposed longitudinally opposite to the first end. The body defines a receiving slot proximal to the first end of the body. The receiving slot defines a top portion. While determining the wear condition of a valve body of the valve, the top portion is adapted to at least partially contact a top surface of the valve body. The wear gauge also includes a movable portion removably coupled to the body and movable relative to the body. The movable portion includes a contact surface. While determining the wear condition of the valve body, the contact surface contacts the wear surface of the valve body. The wear condition of the valve body is determined based on a position of the contact surface of the movable portion with respect to the top portion of the receiving slot. The wear gauge further includes at least one fastening element that removably couples the movable portion with the body.

In yet another aspect of the present disclosure, a kit is provided. The kit includes a valve body for a suction valve or a discharge valve of a frac pump. The valve body defines a top surface and a wear surface. The kit also includes a wear gauge for determining a wear condition of the wear surface of the valve body caused by an operation of the frac pump. The wear gauge includes a body defining a first end and a second end disposed longitudinally opposite to the first end. The body defines a receiving slot proximal to the first end of the body. The receiving slot defines a top portion. While determining the wear condition of a valve body of the valve, the top portion is adapted to at least partially contact a top surface of the valve body. The wear gauge also includes a movable portion removably coupled to the body and movable relative to the body. The movable portion includes a contact surface. While determining the wear condition of the valve body, the contact surface contacts the wear surface of the valve body. The wear condition of the valve body is determined based on a position of the contact surface of the movable portion with respect to the top portion of the receiving slot. The wear gauge further includes at least one fastening element that removably couples the movable portion with the body.

Other features and aspects of this disclosure will be apparent from the following description and the accompanying drawings.

### BRIEF DESCRIPTION OF THE DRAWINGS

FIG. 1 is a partial cross-sectional view of a fluid end of a frac pump, according to an example of the present disclosure;

FIG. 2 is a schematic perspective view of a wear gauge determining a wear condition of a wear surface of a suction valve or a discharge valve of the frac pump of FIG. 1, according to an example of the present disclosure;

FIG. 3 is a schematic front view of the wear gauge of FIG. 2 in contact with the valve body and illustrating a new condition of the valve body;

FIG. 4 is a schematic perspective view of the wear gauge of FIG. 2 illustrating between new and end-of-life wear condition of the valve body;

FIG. 5 is a schematic front view of the wear gauge of FIG. 2 illustrating an end-of-life wear condition of the valve body;

FIG. 6 is a block diagram of a kit including the wear gauge of FIG. 2 and the valve body, according to an example of the present disclosure; and

FIG. 7 is a flowchart for a method of determining the wear condition of the wear surface of the suction valve or the discharge valve of the frac pump of FIG. 1, according to an example of the present disclosure.

### DETAILED DESCRIPTION

Wherever possible, the same reference numbers will be used throughout the drawings to refer to the same or like parts.

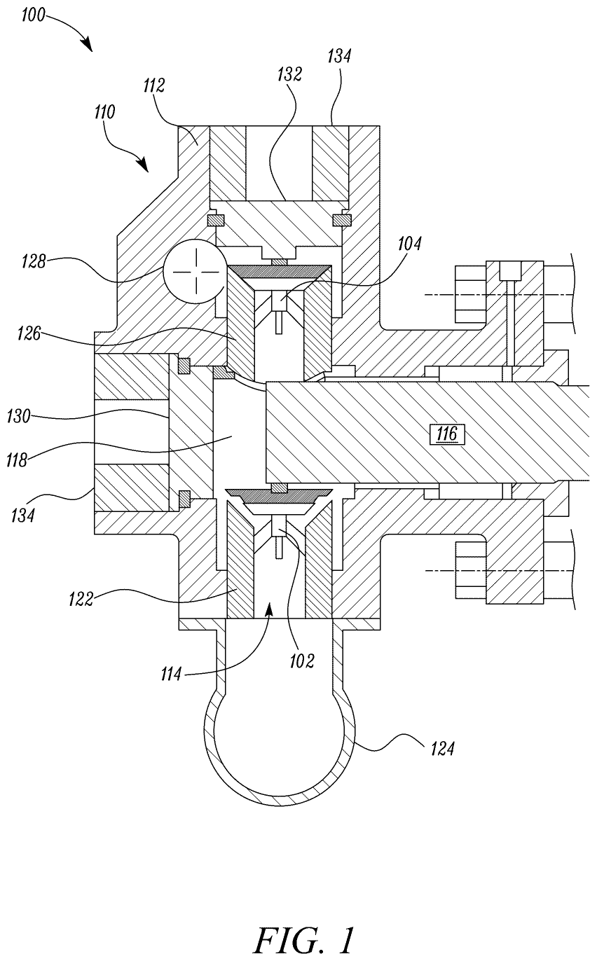

Referring to FIG. 1, a partial cross-sectional view of a fluid end 110 of a frac pump 100 is illustrated. The frac pump 100 may include any type of positive displacement pump. In an example, the frac pump 100 may include a reciprocating pump. Further, the frac pump 100 may be used in well stimulation arrangements as a hydraulic fracturing pump to pressurize high pressure fracturing (fracking) fluids into wells for recovery of oil and gas trapped in shale formations and the like. Alternatively, the frac pump 100 may be replaced by any other type of pump.

The frac pump 100 has two sections, a power end (not shown) and the fluid end 110 connected to the power end by a stay rod assembly (not shown). The power end (not shown) is driven by a diesel engine (not shown) and a transmission (not shown), a gas turbine engine, and/or an electric motor. Further, the fluid end 110 is supplied with fracking fluid containing water and other ingredients. The fluid end 110 receives the fracking fluid via an inlet 114. Further, the fracking fluid is pressurized by the fluid end 110 and discharged through an outlet (not shown).

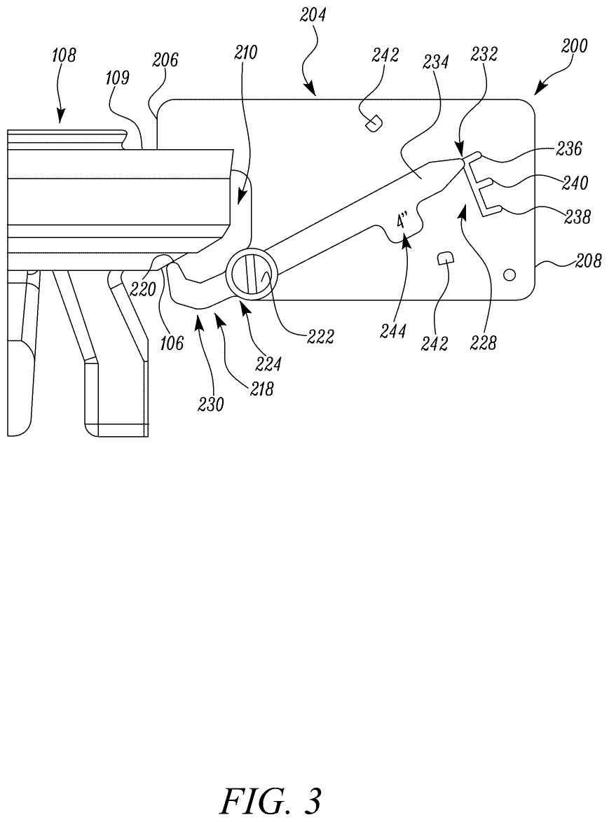

The fluid end 110 includes a fluid end body 112. In an example, the fluid end body 112 may be made of stainless steel. The fluid end 110 also includes a plunger 116 having a piston that slides coaxially inside a fluid chamber 118, alternately increasing and decreasing chamber volume. The plunger 116 operates to draw the fracking fluid from a suction manifold 124 into the fluid chamber 118 through a suction valve 102 forming a sealing interface with a suction valve seat 122. The fracking fluid is discharged at a high pressure through a discharge valve 104 that forms a sealing interface with a discharge valve seat 126 to a discharge manifold 128. The suction valve 102 is covered by a suction valve cover 130 and the discharge valve 104 is covered by a discharge valve cover 132. A threaded retainer 134 is used to removably secure the suction valve cover 130 on the suction valve 102. Further, a threaded retainer 134 is also used to removably secure the discharge valve cover 132 on the discharge valve 104. Furthermore, each of the suction valve 102 and the discharge valve 104 includes a valve body 108 (shown in FIG. 3).

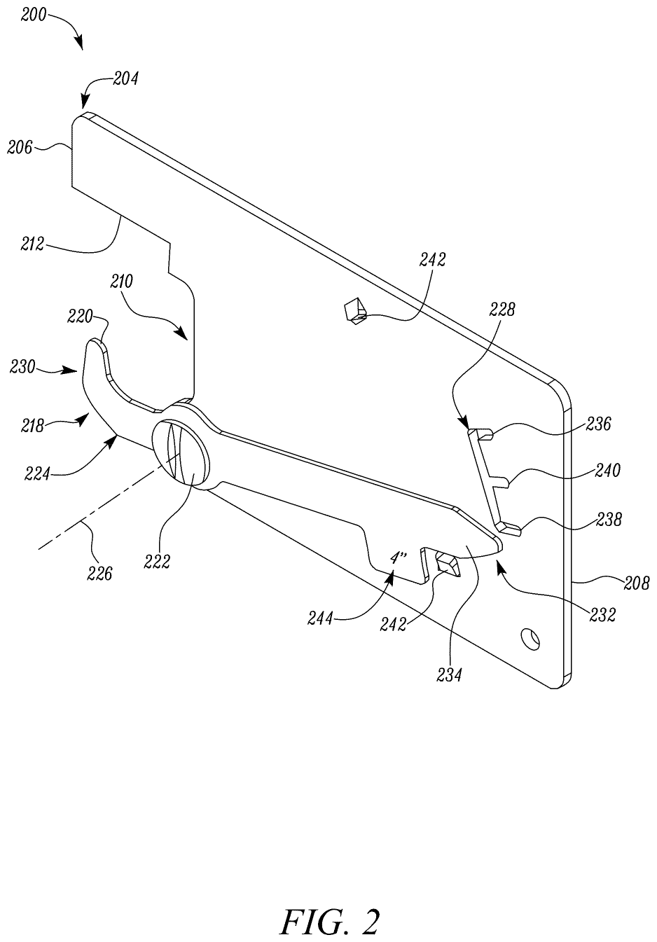

Referring to FIGS. 1 and 2, the present disclosure relates to a wear gauge 200 for determining a wear condition of a wear surface 106 (shown in FIG. 3) of the suction valve 102 or the discharge valve 104 of the frac pump 100 (specifically, the fluid end 110) caused by an operation of the frac pump 100. Over a period of time, the wear surface 106 of the valve body 108 wears out due to continued operation of the frac pump 100. The valve body 108 may have to be replaced if the wear surface 106 is completely worn-out, in order to ensure continued operation of the frac pump 100.

As shown in FIGS. 2 and 3, the wear gauge 200 includes a body 204 defining a first end 206 and a second end 208 disposed longitudinally opposite to the first end 206. The body 204 defines a receiving slot 210 proximal to the first end 206 of the body 204. The receiving slot 210 is defined on the body 204. Specifically, the receiving slot 210 is a slot that can receive a portion of the valve body 108 therein. The body 204 is rectangular in shape herein. Alternatively, the body 204 may have any other shape. It should be noted that the body 204 has a thickness that is nominal compared to a length and a width of the body 204. As such, the body 204 is embodied as a card, and may be made of a polymer, a metal, and so on.

The receiving slot 210 defines a top portion 212. While determining the wear condition of the valve body 108 of the valve 102, 104 (see FIG. 1), the top portion 212 at least partially contacts a top surface 109 of the valve body 108. The tope surface 109 and the wear surface 106 are defined at opposite sides of the valve body 108. The body 204 further includes a number of wear indicator markings 228. The wear indicator markings 228 are proximal to the second end 208 of the body 204. The wear condition of the wear surface 106 is determined based on determining that the wear condition is one of new, end-of-life, or between new and end-of-life. In other words, the number of wear indicator markings 228 includes three wear indicator markings 236, 238, 240 which indicate to a user the extent of wear that has taken place on the valve body 108.

Referring now to FIG. 2, the wear gauge 200 further includes a movable portion 218 removably coupled to the body 204 and movable relative to the body 204. The movable portion 218 includes a lever 224 that is removably coupled to the body 204 about a rotation axis 226. The movably portion 218 has an L-shaped structure herein. The movable portion 218 includes a contact surface 220.

The movable portion 218 of the wear gauge 200 is compatible with only one valve size. In some examples, the movable portion 218 further includes a visible indicator 244 of a compatible valve size. The visible indicator 244 may display a valve size of the valve body 108 that is compatible with the movable portion 218. For example, if the valve size is 4 inches (″), then the visible indicator 244 may include the indication 4″. In some examples, the movable portion 218 is a first movable portion 218 that is compatible with a first valve size. The movable portion 218 is hereinafter interchangeably referred to as “the first movable portion”. In another example, the movable portion 218 is replaceable with a second movable portion (not shown) that is compatible with a second valve size that is different from the first valve size. It should be noted that the second movable portion is similar in design to the first movable portion 218.

The wear gauge 200 further includes one or more fastening elements 222 that removably couple the movable portion 218 with the body 204. In the illustrated example of FIG. 2, the one or more fastening elements 222 is a single screw as shown in FIG. 2. In some examples, the one or more fastening elements 222 may be a bolt and nut assembly or a snap-fit joint.

Further, the contact surface 220 is defined at a first end 230 of the lever 224 with respect to the rotation axis 226. The lever 224 includes a wear indicator 232 defined on a portion 234 of the lever 224 opposite the first end 206 with respect to the rotation axis 226. The wear indicator 232 overlaps with a particular wear indicator marking 236, 238, 240 from the number of wear indicator markings 228. The wear condition of the wear surface 106 is determined based on an identification of the particular wear indicator marking 228 that is overlapping with the wear indicator 232.

The body 204 further includes a pair of limit stops 242. The pair of limit stops 242 are proximal to the second end 208 of the body 204. The pair of limit stops 242 are angularly spaced apart from each other. The pair of limit stops 242 restrict a movement of the lever 224 beyond a predetermined region. In other words, the pair of limit stops 242 restrict a movement of the lever 224 beyond a perimeter of the body 204.

Referring now to FIGS. 3 to 5, while determining the wear condition of the valve body 108, the contact surface 220 contacts the wear surface 106 of the valve body 108. The wear condition of the valve body 108 is determined based on a position of the contact surface 220 of the movable portion 218 with respect to the top portion 212 (see FIG. 2) of the receiving slot 210. Specifically, as illustrated in FIG. 3, the wear surface 106 of the valve body 108 is in original shape and consequently, the wear indicator 232 overlaps with the wear indicator marking 236, thereby indicating a new condition of the wear surface 106 of the valve body 108. As such, when the wear condition is new, the contact surface 220 of the movable portion 218 is farthest from the top portion 212 of the receiving slot 210.

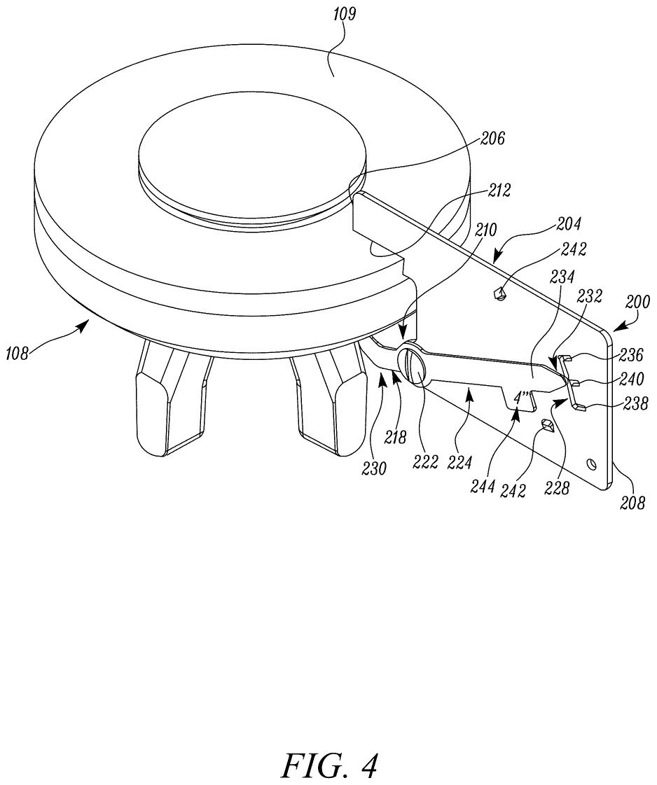

Further, as illustrated in FIG. 4, the wear surface 106 of the valve body 108 is partially worn out and consequently, the wear indicator 232 overlaps with the wear indicator marking 240, thereby indicating that the wear condition of the wear surface 106 is between new and end-of-life.

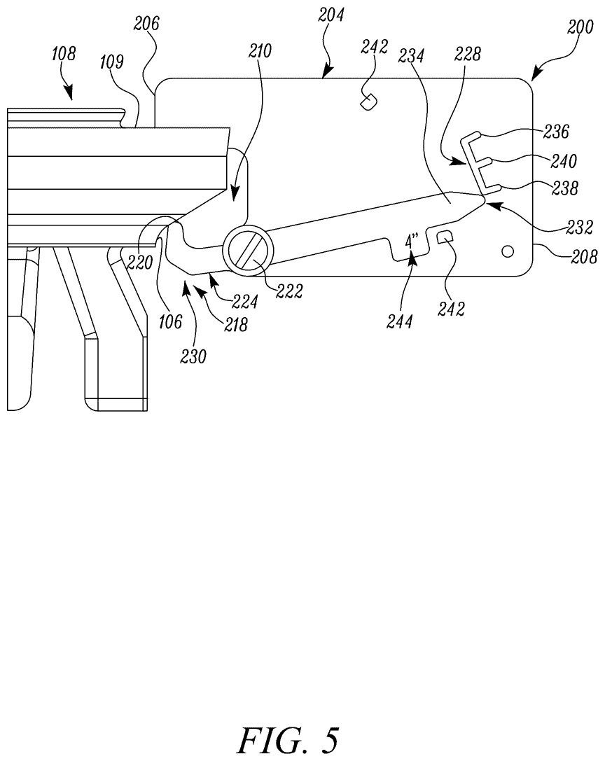

Furthermore, as illustrated in FIG. 5, the wear surface 106 of the valve body 108 is worn-out and the valve body 108 may not be usable. Consequently, the wear indicator 232 overlaps with the wear indicator marking 238, thereby indicating an end-of-life wear condition of the wear surface 106 of the valve body 108. Further, when the wear condition is end-of-life, the contact surface 220 of the movable portion 218 is closest to the top portion 212 (see FIG. 2) of the receiving slot 210.

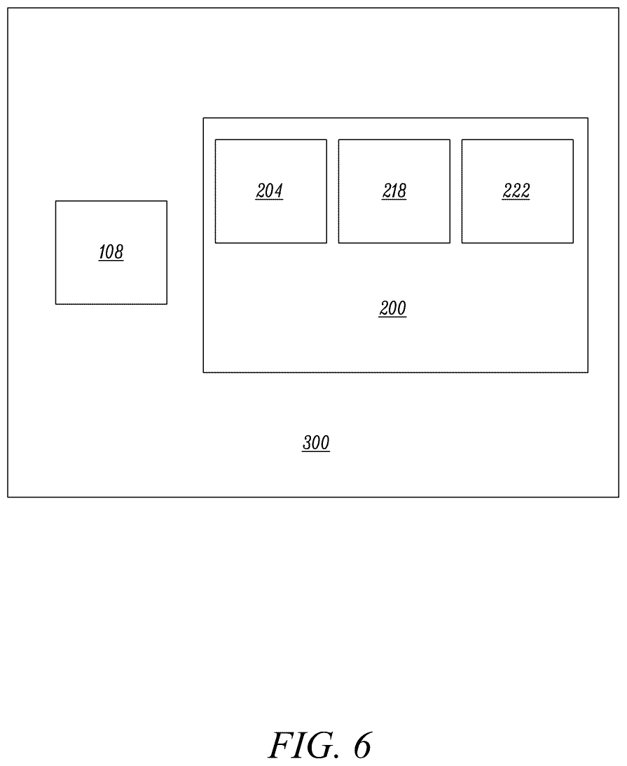

Referring now to FIG. 6, a block diagram of a kit 300 is illustrated. The kit 300 includes the valve body 108 for the suction valve 102 (see FIG. 1) or the discharge valve 104 (see FIG. 1) of the frac pump 100 (see FIG. 1). The kit 300 also includes the wear gauge 200 as explained in relation to FIGS. 2 to 5.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure relates to the wear gauge 200 and a method 400 of determining the wear condition of the wear surface 106 of the suction valve 102 or the discharge valve 104 of the frac pump 100 caused by the operation of the frac pump 100.

The wear gauge 200 and the method 400 described herein provides a quick and easy way to accurately determine the wear condition of the wear surface 106 of the valve body 108, thereby allowing preventive maintenance by identifying when the valve body 108 needs to be replaced before failures. The method 400 allows users to identify excessive wear on the valve body 108 before they fail completely, thereby preventing unexpected breakdowns and downtime.

The wear gauge 200 has a simple structure, is easy to manufacture, is light weight, and is cost effective. Additionally, the wear gauge 200 is user friendly, and requires minimal technical expertise. Further, the wear gauge 200 may be used for a number of valve sizes by simply replacing the movable portion 218. Furthermore, the movable portion 218 may be quickly removed and replaced with another movable portion based on the valve size under test.

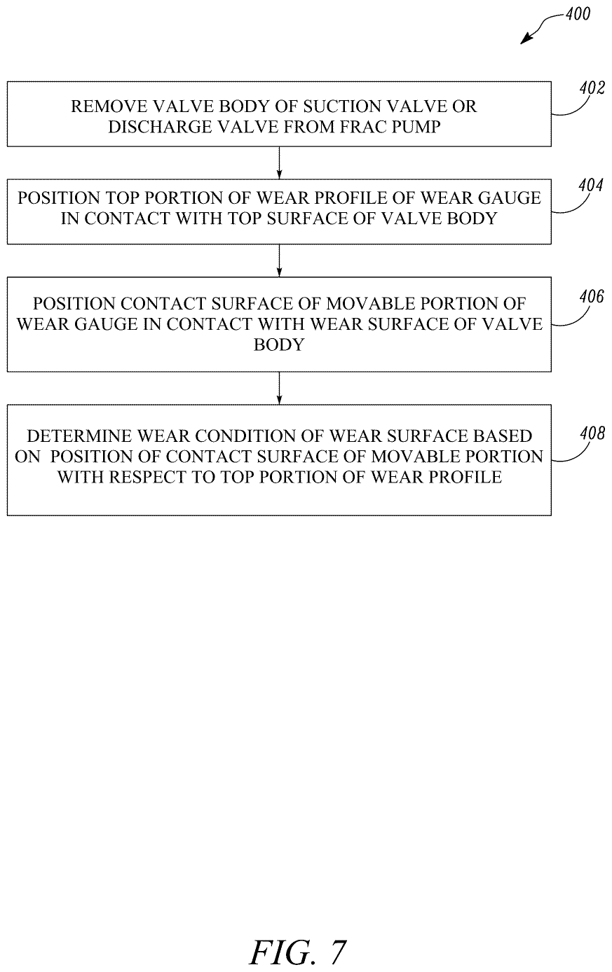

Referring to FIG. 7, a flowchart for the method 400 of determining the wear condition of the wear condition of the wear surface of the wear surface 106 (see FIG. 3) of the suction valve 102 (see FIG. 1) or the discharge valve 104 (see FIG. 1) of the frac pump 100 (see FIG. 1) is shown.

Referring to FIGS. 1 to 7, at step 402, the valve body 108, of the suction valve 102 or the discharge valve 104, is removed from the frac pump 100.

At step 404, the top portion 212 of the receiving slot 210 of the wear gauge 200 is positioned in contact with the top surface 109 of the valve body 108. The wear gauge 200 includes the body 204. The receiving slot 210 is defined on the body 204. The body 204 further includes the number of wear indicator markings 228.

At step 406, the contact surface 220 of the movable portion 218 of the wear gauge 200 is positioned in contact with the wear surface 106 of the valve body 108. The movable portion 218 includes the lever 224 that is removably coupled to the body 204 about the rotation axis 226. The contact surface 220 is defined at the first end 230 of the lever 224 with respect to the rotation axis 226. The lever 224 includes the wear indicator 232 defined on the portion 234 of the lever 224 opposite the first end 230 with respect to the rotation axis 226. Based on the wear condition, the wear indicator 232 overlaps with the particular wear indicator marking 236, 238, 240 from the number of wear indicator markings 228. The movable portion 218 of the wear gauge 200 is compatible with only one valve size and includes the visible indicator 244 of the compatible valve size.

At step 408, the wear condition of the wear surface 106 is determined based on the position of the contact surface 220 of the movable portion 218 with respect to the top portion 212 of the receiving slot 210. At the step 408, it is determined if the wear condition is one of new, end-of-life, or between new and end-of-life. The method 400 further includes a step (not shown) at which the valve body 108 is installed in the frac pump 100 based on determining that the wear condition is new or between new and end-of-life or the valve body 108 is not installed in the frac pump 100 based on determining that the wear condition is end-of-life.

The method 400 further includes a step (not shown) at which the particular wear indicator marking 228 that is overlapping with the wear indicator 232 is identified. The method 400 further includes a step (not shown) at which the wear condition of the wear surface 106 is determined, based on identifying the particular wear indicator marking 236, 238, 240.

In some examples, the movable portion 218 is the first movable portion 218 that is compatible with the first valve size. The method 400 further includes a step (not shown) at which the first movable portion 218 is replaced with the second movable portion that is compatible with the second valve size that is different from the first valve size.

It should be noted that the steps 402, 404, 406, 408 of the method 400 may be performed in a sequence that is different from that explained in relation to FIG. 7. Further, various steps 402, 404, 406, 408 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A method of determining a wear condition of a wear surface of a suction valve or a discharge valve of a frac pump caused by an operation of the frac pump, comprising:
removing a valve body, of the suction valve or the discharge valve, from the frac pump;
positioning a top portion of a receiving slot of a wear gauge in contact with a top surface of the valve body;
positioning a contact surface of a movable portion of the wear gauge in contact with the wear surface of the valve body; and
determining the wear condition of the wear surface based on a position of the contact surface of the movable portion with respect to the top portion of the receiving slot.

2. The method of claim 1, wherein the wear gauge includes a body, and wherein the movable portion includes a lever that is removably coupled to the body about a rotation axis.

3. The method of claim 2, wherein the receiving slot is defined on the body, and wherein the body further includes a plurality of wear indicator markings.

4. The method of claim 3, wherein the contact surface is defined at a first end of the lever with respect to the rotation axis, wherein the lever includes a wear indicator defined on a portion of the lever opposite the first end with respect to the rotation axis, and wherein, based on the wear condition, the wear indicator overlaps with a particular wear indicator marking from the plurality of wear indicator markings.

5. The method of claim 4, further comprising:
identifying the particular wear indicator marking that is overlapping with the wear indicator; and
determining, based on identifying the particular wear indicator marking, the wear condition of the wear surface.

6. The method of claim 5, further comprising:
determining the wear condition of the wear surface includes determining that the wear condition is one of new, end-of-life, or between new and end-of-life; and
causing at least one of:
the valve body to be installed in the frac pump based on determining that the wear condition is new or between new and end-of-life; or
the valve body to not be installed in the frac pump based on determining that the wear condition is end-of-life.

7. The method of claim 1, wherein the movable portion of the wear gauge is compatible with only one valve size and includes a visible indicator of a compatible valve size.

8. The method of claim 7, wherein the movable portion is a first movable portion that is compatible with a first valve size, the method further comprising:
replacing the first movable portion with a second movable portion that is compatible with a second valve size that is different from the first valve size.

9. A wear gauge for determining a wear condition of a wear surface of a suction valve or a discharge valve of a frac pump caused by an operation of the frac pump, the wear gauge comprising:
a body defining a first end and a second end disposed longitudinally opposite to the first end, wherein the body defines a receiving slot proximal to the first end of the body, wherein the receiving slot defines a top portion, and wherein, while determining the wear condition of a valve body of the valve, the top portion is adapted to at least partially contact a top surface of the valve body;
a movable portion removably coupled to the body and movable relative to the body, wherein the movable portion includes a contact surface, wherein, while determining the wear condition of the valve body, the contact surface contacts the wear surface of the valve body, and wherein the wear condition of the valve body is determined based on a position of the contact surface of the movable portion with respect to the top portion of the receiving slot; and
at least one fastening element that removably couples the movable portion with the body.

10. The wear gauge of claim 9, wherein the movable portion includes a lever that is removably coupled to the body about a rotation axis.

11. The wear gauge of claim 10, wherein the receiving slot is defined on the body, and wherein the body further includes a plurality of wear indicator markings.

12. The wear gauge of claim 11, wherein the contact surface is defined at a first end of the lever with respect to the rotation axis, wherein the lever includes a wear indicator defined on a portion of the lever opposite the first end with respect to the rotation axis, wherein, based on the wear condition, the wear indicator overlaps with a particular wear indicator marking from the plurality of wear indicator markings, and wherein the wear condition of the wear surface is determined based on an identification of the particular wear indicator marking that is overlapping with the wear indicator.

13. The wear gauge of claim 10, wherein the wear condition of the wear surface is determined based on determining that the wear condition is one of new, end-of-life, or between new and end-of-life.

14. The wear gauge of claim 13, wherein the body includes a pair of limit stops, wherein the pair of limit stops are angularly spaced apart from each other, and wherein the pair of limit stops are adapted to restrict a movement of the lever beyond a predetermined region.

15. The wear gauge of claim 9, wherein the movable portion of the wear gauge is compatible with only one valve size and includes a visible indicator of a compatible valve size.

16. The wear gauge of claim 9, wherein the movable portion is a first movable portion that is compatible with a first valve size, and wherein the movable portion is replaceable with a second movable portion that is compatible with a second valve size that is different from the first valve size.

17. A kit comprising:
a valve body for a suction valve or a discharge valve of a frac pump, the valve body defining a top surface and a wear surface; and
a wear gauge for determining a wear condition of the wear surface of the valve body caused by an operation of the frac pump, the wear gauge comprising:
a body defining a first end and a second end disposed longitudinally opposite to the first end, wherein the body defines a receiving slot proximal to the first end of the body, wherein the receiving slot defines a top portion, and wherein, while determining the wear condition of a valve body of the valve, the top portion is adapted to at least partially contact a top surface of the valve body;
a movable portion removably coupled to the body and movable relative to the body, wherein the movable portion includes a contact surface, wherein, while determining the wear condition of the valve body, the contact surface contacts the wear surface of the valve body, and wherein the wear condition of the valve body is determined based on a position of the contact surface of the movable portion with respect to the top portion of the receiving slot; and
at least one fastening element that removably couples the movable portion with the body.

18. The kit of claim 17, wherein the receiving slot is defined on the body, and wherein the body further includes a plurality of wear indicator markings.

19. The kit of claim 18, wherein the movable portion includes a lever that is removably coupled to the body about a rotation axis, wherein the contact surface is defined at a first end of the lever with respect to the rotation axis, wherein the lever includes a wear indicator defined on a portion of the lever opposite the first end with respect to the rotation axis, wherein, based on the wear condition, the wear indicator overlaps with a particular wear indicator marking from the plurality of wear indicator markings, and wherein the wear condition of the wear surface is determined based on an identification of the particular wear indicator marking that is overlapping with the wear indicator.

20. The kit of claim 19, wherein the wear condition of the wear surface is determined based on determining that the wear condition is one of new, end-of-life, or between new and end-of-life.
